(19) United States
(12) Patent Application Publication
(10) Pub. No.: US 2011/0293914 A1
(43) Pub. Date: Dec. 1, 2011

(54) SHAPED FOAM COMPOSITE ARTICLE

(76) Inventors: Myron J. Maurer, Saginaw, MI (US); David H. Bank, Midland, MI (US); Jack E. Hetzner, Reese, MI (US); George A. Klumb, Novi, MI (US); Matthew D. Mittag, Midland, MI (US); Jason A. Reese, Auburn, MI (US); Alain Sagnard, Lachen (CH); Parvinder S. Walia, Midland, MI (US)

(21) Appl. No.: 13/109,098

(22) Filed: May 17, 2011

Related U.S. Application Data
(60) Provisional application No. 61/348,773, filed on May 27, 2010.

(51) Int. Cl. B32B 5/20; C08L 25/06; B32B 37/18

(52) U.S. Cl. 428/304.4; 156/78; 521/146

(57) ABSTRACT

The present invention is a method to manufacture shaped foam composite articles comprising a foam core and one or more skin and shaped foam composite articles made therefrom. Specifically, cold formed shaped foam articles having an upper and lower surface having a skin applied to one or both of the surfaces. Preferably the foam comprises a styrenic polymer foam and the skins may independently be mono-layered or multi-layered. The shaped foam article and the skin may be made from the same or different materials. In the case where there are more than one skin, the skins may comprise the same or different materials.

### CROSS REFERENCE STATEMENT

This application claims the benefit of U.S. Provisional Application Ser. No. 61/348,773, filed May 27, 2010, which is incorporated herein by reference.

### BACKGROUND OF THE INVENTION

The present invention is a shaped foam composite article and method for manufacturing such an article. Specifically, the shaped foam composite article is a multi-layered article wherein one of the layers comprises a cold formed shaped foam.

Foam composite articles can be used for doors, wash basins, shower and bath surrounds, refrigerator and freezer panes, surfboards, pallets, doors, transformer mounting pads, automotive articles, and the like. Foam composite articles demonstrate many advantages compared to counterparts that are solely foamed or solely solid. For instance, a foam composite article may demonstrate better a blend of performance properties at lighter weight and/or a lower cost to manufacture.

One approach to a foam composite article is structural foam molding providing an article with a high density shell and an integral lower density core, see U.S. Pat. No. 3,268,636. However, articles produced by this process have essentially the same chemical and visual characteristics throughout their cross-section, so that the high density shell will have properties very similar to that of the lower density core.

Various methods to form foamed composite articles wherein the foamed article and the laminated surface may comprise different materials are known. For instance, U.S. Pat. No. 2,806,812 discloses a method for the preparation of a planar foam composite article comprising thermoplastic sheets having a resin foam integrally bonded thereto. These sheets are made by preparing a mold assembly into which foamable resin beads are placed, after which the beads are foamed, a sheet of thermoplastic resin is applied to the top surface of the mold cavity containing the foamed beads, and atmospheric pressure is used to force the thermoplastic sheet into pressured engagement with the face of the resin foam.

U.S. Pat. No. 4,350,730 discloses a process to produce a planar foamed composite article wherein two solid thermoplastic sheets are fusion bonded to a foam resin core.

U.S. Pat. No. 4,944,416 discloses a method to make a planar foamed composite article wherein polymeric beads are expanded then compressed to a desired density to form a foamed core and then skins, such as FORMICA or plastic sheets, are adhesively bonded to the foamed core. This process is limited to planar articles and the procedures are described as expensive and time consuming.

U.S. Pat. No. 5,401,456 discloses a pallet made by first forming a substantially flat foamed core which is placed between vacuum formed top and bottom sheets. However, this method requires pre-forming the skins and a very specialized molding apparatus comprising, among other things, a carousel mechanism.

U.S. Pat. No. 3,090,078 discloses a process for foaming or expanding a resin between a pair of skin surfaces in situ. However, this method is limited to planar applications wherein the expandable resins are of the type employing water vapor for blowing purposes.

U.S. Pat. No. 3,910,747 discloses a multi-step method to form a shaped foamed composite article within a thermoforming or vacuum forming machine by first thermoforming or vacuum forming an upper and lower thermoplastic sheet on their respective die faces and then inserting a pre-formed foamed article between the formed upper and lower sheets before the press closes. This method has the disadvantage that it requires multiple steps including pre-forming the skins.

U.S. Pat. No. 4,053,545 discloses a method for forming shaped foamed composite plastic devices by thermoforming a thermoplastic sheet to the general outer contour of a desired article. Then placing the thermoformed thermoplastic sheet within a cavity of a heated mold and injecting the cavity with foamable polymer. However, this process is a multi-step, multi-mold process requiring a long cycle time because of the necessity to heat the final mold.

U.S. Pat. No. 5,811,039 discloses a process for fabricating shaped foamed composite articles of thermoplastic material including a foamed core bonded to a compatible thermoplastic sheet. A sheet of thermoplastic material is first preheated and then vacuum formed on a first half-mold. The first half-mold with the thermoformed sheet is positioned opposite a second half-mold to form a hollow chamber therebetween. A foamable thermoplastic material containing one or more liquid hydrocarbons is injected into the hollow space at a temperature sufficiently high to permit the foamable material to expand and bond to the thermoformed sheet. However, complex equipment is required for such a process. Further, the shaped foamed article is limited to having a thermoplastic sheet on only one surface.

U.S. Pat. No. 6,401,414 discloses a process to make a planar foamed composite, such as a door, wherein thermoplastic skins are vacuum formed then adhesively bonded to a rigid foam core having frangible cells, wherein said cells are capable of conforming to depressed zones in the vacuum formed skins by crumbling under compression. This process requires multi-steps, is time consuming, and is limited to planar articles.

In addition to producing skins, or half shells, by thermoforming or vacuum forming, foamed composite articles may by fabricated by blow molding or injection molding, two half-shells which are assembled with each other by gluing or welding; the hollow chamber comprised between both half-shells is then filled with foam, such as foamed polyurethane by the well known reaction injection molding (RIM) technology.

These patents are illustrative of the varied techniques in the prior art to manufacture foamed composite articles. However, they suffer from a variety of drawbacks. It would be desirable to have a simple, cost effective method to make a foam composite article in which the article preferably can be, but is not limited to being shaped and the skins can be a different material than the foam core and the process does not require combinations of expensive and/or complex equipment, multiple steps, multiple molds, and/or adhesives to bond the skin(s) to the foam core.

### SUMMARY OF THE INVENTION

The present invention is such a simple, cost effective method to make foam composite articles, preferably a shaped foam composite article. The shaped foam composite articles of the present invention eliminate the need for complex equipment, multiple molds, and long cycle times.

In one embodiment, the present invention is a method to manufacture a shaped foam composite article comprising a method to prepare a shaped foam composite article comprising a foam core and one or more skin comprising the steps of (A) preparing a foam core by the steps comprising (i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4 and (ii) forming a foam blank from the foam plank by preparing one or more pressing surface, (B) applying one or more skin onto one or more surface of the foam core, and providing shape to the foam core, wherein the skin(s) conform to the shape of the foam core providing a shaped foam composite article.

Another embodiment, the present invention is a method to manufacture a shaped foam composite article comprising a foam core and one or more skin comprising the steps of:
(A) preparing a foam core comprising a shaped foamed article comprising the steps of:
   (i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4,
   (ii) forming a foam blank from the foam plank by preparing one or more pressing surface,
   (iii) shaping the pressing surface(s) of the foam blank to provide a shaped foam article:
      (iii)(a) optionally contacting each pressing surface of the foam blank with a mold, said mold comprises one or a plurality of cavities each cavity having a perimeter defining the shape of the shaped foam article and a cavity surface
      and
      (iii)(b) optionally pressing the foam blank with the mold at an applied strain whereby forming one or more shaped foam article and surrounding continuous unshaped foam blank.

Another embodiment of the present invention is a method to manufacture a shaped foam composite article comprising a foam core and one or more skin comprising the steps of:
(A) preparing a foam core comprising the steps of:
   (i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4 and
   (ii) forming a foam blank from the foam plank by preparing one or more pressing surface,
(B) applying a skin onto one or more pressing surface to provide a foam composite blank,
and
(C) shaping the foam composite blank into a shaped foam composite article,
   wherein one or more skin may independently be a mono-layer skin, a multi-layer skin, or combinations thereof.

In one embodiment of the present invention the blowing agent is a chemical blowing agent, an inorganic gas, an organic blowing agent, or combinations thereof, preferably the blowing agent is carbon dioxide, water or a combination thereof.

In another embodiment of the present invention the thermoplastic polymer is a styrene polymer, a styrene and acrylonitrile copolymer, or mixtures thereof.

In another embodiment of the present invention one or more skin comprises one or more layer independently comprising a thermoplastic polymer, thermoset polymer, a metal, a wood veneer, cloth, fabric, paint, stone, paper, paper board, a reinforcing material, a fiber mat, leather, concrete, ceramic, or combinations thereof, preferably one or more mono-layer skin and/or one or more multi-layer skin comprises a sheet or a film. Preferably the sheet or film comprises a thermoplastic polymer selected from polystyrene; high impact polystyrene; styrene and acrylonitrile copolymer; acrylonitrile, butadiene, and styrene terpolymer; polyphenyleneoxide; polycarbonate; polyethylene terephthalate; polybutylene terephthalate; copolymers of PE with a C₃ to C₂₀ alpha-olefin, high density polyethylene, low density polyethylene, linear low density polyethylene, substantially linear ethylene polymer, linear ethylene polymer; polypropylene homopolymer; random copolymer of polypropylene; block copolymer of polypropylene; copolymer of propylene with a C₄ to C₂₀ alpha-olefin; thermoplastic polyolefin; olefinic thermoplastic elastomer; chlorinated polyethylene; polyvinyl chloride; polytetrafluoroethane; polyurethane; thermoplastic polyurethane; polyacrylic acid; polybutyl acrylate; polymethacrylate; polymethyl methacrylate; polyamide; and blends thereof.

In another embodiment of the present invention one or more skin comprises one or more layer independently comprising a thermoset polymer and optionally a reinforcing material wherein curing of the thermoset polymer may occur prior to the shaping step, concurrently with the shaping step, or after the shaping step.

In another embodiment of the present invention the one or more skin is adhered to the shaped foam article by thermal means, mechanical means, physical means, chemical means, adhesive means, or combinations thereof.

Another embodiment of the present invention is a shaped foam composite article made by the methods described hereinabove.

### BRIEF DESCRIPTION OF THE DRAWINGS

FIG. 1 is an illustration of the step change in the shaped foam article of this invention.

FIG. 2 is a cross-sectional view of a foam plank.

FIG. 3 is a cross-sectional view of a forming tool with foam plank in the open position prior to shaping.

FIG. 4 is a cross-sectional view of a forming tool with trimmed and shaped foamed plank in the closed position.

FIG. 5 is a cross-sectional view of a forming tool with shaped foam article in the open position after shaping.

FIG. 6 is an illustration of a non-continuous method of the present invention.

FIG. 7 is an illustration of a second non-continuous method of the present invention.

FIG. 8 is an illustration of a continuous method of the present invention.

FIG. 9 is an illustration of a second continuous method of the present invention.

FIG. 10 is an illustration of a third continuous method of the present invention.

FIG. 11 is a photograph of a first forming tool used to form a shaped foam article of this invention.

FIG. 12 is a photograph of a second forming tool used to form a shaped foam article of this invention.

FIG. 13 is a photograph of a first shaped foam article made using a method of this invention.

FIG. 14 is a photograph of a second shaped foam article made using a method of this invention.

FIG. 15 is a photograph of a shaped foam composite article made using a method of this invention.

FIG. 16 is a photograph showing a mold pressing surface for pressing a foam plank into a shaped foam article resembling a panel Spanish roofing tiles.

FIG. 17 is a photograph a of shaped foam article having the shape of Spanish roofing tiles.

### DETAILED DESCRIPTION OF THE INVENTION

The shaped foam composite article of the present invention comprises a three-dimensional shaped foam core having an upper (or top) surface and a lower (or bottom) surface wherein either one or both of the upper surface and/or lower surface have a shape imparted therein. The foam core may be referred to as a foam blank prior to shaping or a shaped foam article after shaping. The shaped foam composite article of the present invention further comprises one or more skin applied to, sometimes referred to as laminated to or adhered to, the upper surface of the shaped foam core, the lower surface of the shaped foam core, or both the upper and lower surface of the shaped foam core.

In one embodiment of the present invention there is a skin applied to the upper surface of the shaped foam core with no skin applied to the lower surface of the shaped foam core. In another embodiment of the present invention there is a skin applied to the lower surface of the shaped foam core and no skin applied to the upper surface of the shaped foam core. In yet another embodiment of the present invention there is a first skin applied to the upper surface of the shaped foam core and a second skin applied to the lower surface of the shaped foam core wherein the first skin has the same composition as the second skin. This structure is referred to as symmetrical and may be represented as an ABA structure where A represents the skins and B represents the foam core. In another embodiment there is a first skin applied to the upper surface of the shaped foam core and a second skin applied to the lower surface of the shaped foam core wherein the first skin has a different composition than the second skin. This structure is referred to as non-symmetrical and may be represented as an ABC structure where A and C represent the two different skins and B represents the foam core.

A skin may comprise one or more layer. A layer typically comprises a sheet (thickness equal to or greater than 100 microns) or a film (thickness less than 100 microns). A skin may have 1 or more layer, for example 2, 3, 4, 5, 6, 7, 8, 9, 10, or more layers. When there are multiple layers in a skin, they may all be different from one another, there may be blocks of repeating layers within a skin, or any combination of the same, similar, and different layers. The composition of a skin is determined by the desired functionality of the skin, it may be aesthetic, structural, barrier, functional, or combinations thereof. The thickness of a skin is dependent upon the skin's composition and number of layers it comprises and is limited only by the means to form the skin and its desired function.

Each layer of a skin will have a first and a second surface. For example, if there are three layers in a skin applied to the upper surface of a shaped foam core, there is the first and second surface of the first layer, the first and second surface of the second layer, and the first and second surface of the third layer. The configuration of the layers may be described by which surfaces of which layers are adjacent to one another. For the above example of a three-layer skin, one configuration of the layers of the skin adhered to the shaped foam core could be: the first surface of the first layer is adjacent to the upper surface of the shaped foam core, the second surface of the first layer is adjacent to the first surface of the second layer, the second surface of the second layer is adjacent to the first surface of the third layer.

A skin may be physically and/or materially bonded to a surface of the shaped foam core. In other words, there may be an adhesive between the skin and the shaped foam core surface. If used, an adhesive may be solid and/or liquid and is selected based on the two materials being bonded. Alternatively, or in addition to, a skin may be welded, by sonic and/or heat means, to a surface of the shaped foam core. Other means to adhere a skin to a foam core and/or shaped foam article are described herein below.

Similarly for a skin, each layer of a skin may be physically and/or materially bonded to the surface of the adjacent layer. There may be an adhesive between one or more of the surfaces of the layers making up the skin. For example, one or more layer of a skin may be an adhesive film. Likewise, in addition to or in place of an adhesive, a skin may be welded, by sonic and/or heat means, to a surface of the adjacent layer. Other means to adhere one layer of a skin to an adjacent, second layer in the skin are described herein below.

In the present invention, the foam core of the shaped foam composite article may be (1) shaped prior to applying the skin(s) or (2) the skin(s) may be applied to the foam core and the composite skin(s)/foam core composition subsequently shaped to form the shaped foam composite article of the present invention. The foam core or shaped foam article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 20 percent or less, more preferably 10 percent or less and still more preferably 5 percent or less and most preferably one percent or less open cell content. A closed cell foam can have zero percent open cell content. Conversely, an open cell foam has 30 percent or more, preferably 50 percent or more, still more preferably 70 percent or more, yet more preferably 90 percent or more open cell content. An open cell foam can have 95 percent or more and even 100 percent open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for the foam article of the present invention.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of their good balance between cost property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides for a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180, 000, 175, 000, 170, 000, 165, 000, 160, 000, 155, 000, 150, 000, 145, 000, 140, 000, 135, 000, 130, 000, 125, 000, 120, 000, 115, 000, 110, 000, 105, 000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared by any conceivable method. Suitable methods for preparing polymeric foam articles include batch processes (such as expanded bead foam processes), semi-batch processes (such as accumulative extrusion processes) and continuous processes such as extrusion foam processes. Desirably, the process is a semi-batch or continuous extrusion process. Most preferably process comprises an extrusion process.

An expanded bead foam process is a batch process that requires preparing a foamable polymer composition by incorporating a blowing agent into granules of polymer composition (for example, imbibing granules of a thermoplastic polymer composition with a blowing agent under pressure). Each bead becomes a foamable polymer composition. Often, though not necessarily, the foamable beads undergo at least two expansion steps. An initial expansion occurs by heating the granules above their softening temperature and allowing the blowing agent to expand the beads. A second expansion is often done with multiple beads in a mold and then exposing the beads to steam to further expand them and fuse them together. A bonding agent is commonly coated on the beads before the second expansion to facilitate bonding of the beads together. The resulting expanded bead foam has a characteristic continuous network of polymer skins throughout the foam. The polymer skin network corresponds to the surface of each individual bead and encompasses groups of cells throughout the foam. The network is of higher density than the portion of foam containing groups of cells that the network encompasses. Accumulative extrusion and extrusion processes produce foams that are free of such a polymer skin network.

The foamed article can also be made in a reactive foaming process, in which precursor materials react in the presence of a blowing agent to form a cellular polymer. Polymers of this type are most commonly polyurethane and polyepoxides, especially structural polyurethane foams as described, for example, in U.S. Pat. Nos. 5,234,965 and 6,423,755, both hereby incorporated by reference. Typically, anisotropic characteristics are imparted to such foams by constraining the expanding reaction mixture in at least one direction while allowing it to expand freely or nearly freely in at least one orthogonal direction.

An extrusion process prepares a foamable polymer composition of a thermoplastic polymer with a blowing agent in an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming. An extruded foam can be a continuous, seamless structure, such as a sheet or profile, as opposed to a bead foam structure or other composition comprising multiple individual foams that are assembled together in order to maximize structural integrity and thermal insulating capability.

Accumulative extrusion is a semi-continuous extrusion process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, hereby incorporated by reference, discloses such a process in a context of making polyolefin foams, yet which is readily adaptable to aromatic polymer foam. U.S. Pat. No. 3,268,636 discloses the process when it takes place in an injection molding machine and the thermoplastic with blowing agent is injected into a mold and allowed to foam, this process is sometimes called structural foam molding.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorintated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The amount of blowing agent can be determined by one of ordinary skill in the art without undue experimentation for a given thermoplastic to be foamed based on the type thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or less than about 160 kg/m³, more preferably equal to or less than about 120 kg/m³, and most preferably equal to or less than about 100 kg/m³.

The cells of the foam article may have an average size (largest dimension) of from about 0.05 to about 5.0 millimeter (mm), especially from about 0.1 to about 3.0 mm, as measured by ASTM D-3576-98. Foam articles having larger average cell sizes, of especially about 1.0 to about 3.0 mm or about 1.0 to about 2.0 mm in the largest dimension, are of particular use when the foam fails to have a compressive ratio of at least 0.4 as described in the following few paragraphs.

In one embodiment of the present invention, to facilitate the shape retention and appearance in the shaped foam article after pressing the shaped foam blank, particularly foams comprising closed cells, it is desirable that the average cell gas pressure is equal to or less than 1.4 atmospheres. In one embodiment, it is desirable that the cell gas pressure is equal to or less than atmospheric pressure to minimize the potential for spring back of the foam after pressing causing less than desirable shape retention. Preferably, the average pressure of the closed cells (i.e., average closed cell gas pressure) is equal to or less than 1 atmosphere, preferably equal to or less than 0.95 atmosphere, more preferably equal to or less than 0.90 atmosphere, even more preferably equal to or less than 0.85 atmosphere, and most preferably equal to or less than 0.80 atmosphere.

Cell gas pressures may be determined from standard cell pressure versus aging curves. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Torr or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

The compressive strength of the foam is determined in accordance with industry standard test methods such as ASTM D1621 or modifications thereof. The compressive strength of the foam article is established when the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T}, has a value of at least 0.40, preferably a value of at least 0.45 and most preferably a value of at least 0.50. When using such a foam, the pressing direction is desirably parallel to the maximum value in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

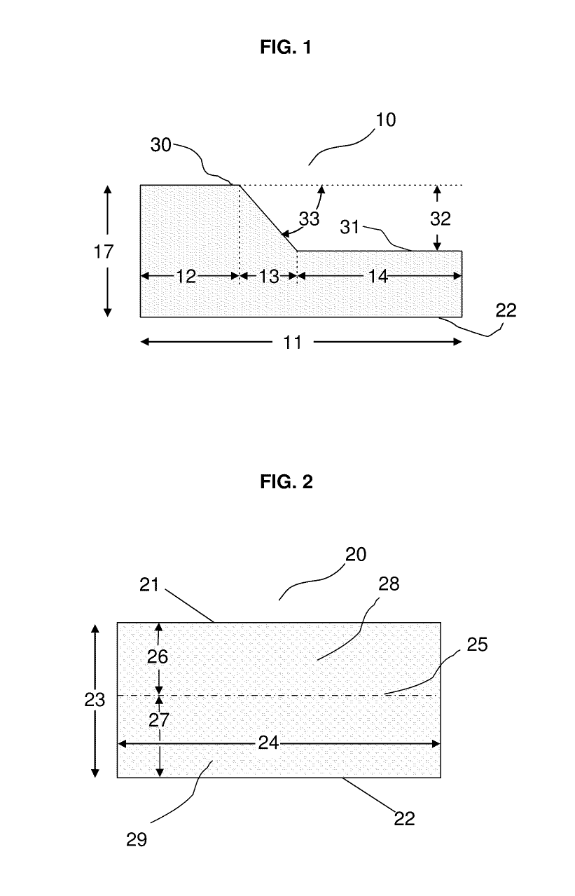

A most preferred foam article is a shaped foam article which may be prepared from a foamed polymer as described hereinabove and further shaped to give a shaped foam article 10. As defined herein, shaped means the foamed article typically has one or more contour that create a step change (impression) in height 32 of at least 1 millimeter or more in the shaped foam article 10 having thickness 17 as shown in FIG. 1. A shaped article has at least one surface that is not planar.

Shaping (1) a foam composite comprising a foam blank comprising one or more skin and/or (2) a foam blank prior to the application of a skin may be accomplished by any means known in the art. For example, the shaped foam article may be foamed in the desired shape, for example by using partially foamed beads of a desired thermoplastic that still have a certain amount of blowing agent and air diffused therein as a result of aging the foam from 12 hours to seven days. The beads are then placed in a mold and heated sufficiently to expand the beads further such that they fill the mold and weld together. For example, foamed polystyrene made this way is typically referred to as expanded polystyrene (EPS) and common examples of EPS foam shaped articles are coffee cups, bike helmets, and the like.

Another process suitable for making a shaped foam article is reaction injection molding (RIM). RIM is a process in which two low molecular weight, highly reactive, low-viscosity liquids are injected at a high pressure into a small mixing chamber and then into a mold cavity. In the mold, the polymerization reaction takes place as the foam shaped article is formed. A preferred two component system comprises one or more polyol and one or more isocyanate to form a polyurethane.

Alternatively, a foam article may be shaped from a foam plank by abrasive wire cutting, hot wire cutting, die cutting, water jet cutting, milling, match mold thermoforming, continuous role forming (sometimes referred to as embossing), or combinations thereof. The use of the term plank, herein, is merely used for convenience with the understanding that configurations other than a flat board having a rectangular cross-section may be extruded and/or foamed (e.g., an extruded sheet, an extruded profile, a pour-in-place bun, etc.). A particularly useful method to shape foam articles is to start from a foam plank which has been extruded from a thermoplastic comprising a blowing agent. As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded.

The forming of the shaped foam articles is surprisingly enhanced by using foam planks that have at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive ratio), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

After the foam plank is formed, a pressing surface is created, for example by removing a layer from the top or bottom surface or cutting the foam plank between the top and bottom surface to create two pressing surfaces opposite the top and bottom surface. A ‘pressing surface’ is defined as the resulting surface on a foam plank after a layer of foam has been removed. Suitable methods that may be useful to remove a layer of foam are cutting using equipment such as band saws, computer numeric controlled (CNC) abrasive wire cutting machines, CNC hot wire cutting equipment and the like. When removing a layer, the same cutting methods just described may be used and other methods such as planing, grinding or sanding may be used.

When a layer is removed from the top and/or bottom surface of a foam plank 20 and/or the foam plank is cut 25, the resulting foam structure is referred to as a ‘foam blank’ 28 and 29 each having a thickness 26 and 27 that is less than the original thickness of the foam plank 23, FIG. 2. If the foam plank is cut in half, i.e., 26=27, then foam blanks 28 and 29 are identical. What differentiates a foam blank form a foam plank is that the foam blank has at least one pressing surface. The foam blank is removed from and/or separated from the foam plank prior to shaping. One or more additional cuts may be necessary to prepare the foam blank to the proper dimensions prior to shaping.

At least one of the cut surfaces (e.g., the surface(s) resulting from the cut 25) of the foam blank becomes the first pressing surface 30. This terminology applies whether the foam plank is cut in half (providing two foam blanks, each with a pressing surface) or only a few millimeters is cut or removed from the surface of the foam plank (providing a single foam blank with a single pressing surface). Multiple (e.g., 2, 3, 4, 5, or more) foam blanks may be cut from a single foam plank (multiple blanks require multiple cuts). The conventional foam blank is rectangular and results from a cut through, and parallel to, the top and bottom surfaces of the foam plank.

Another embodiment is the “near net-shaped foam blank”. A near net-shaped foam blank is formed when the shape of the foam blank is similar to the final shape of the shaped foamed article. In a near net-shaped foam blank sometimes one or more cuts are made in a plane other than parallel to the top and bottom surfaces of the foam plank.

Typically, after the removing or cutting, the plank is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the foam plank having a pressing surface, has a density gradient from the pressing surface to the opposite surface of the foam plank. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the surface (i.e., within a millimeter or two of the surface) is 3.0 pounds per cubic foot (pcf), the density would be for a 10 percent gradient either 2.7 or 3.3 pcf at the center of the foam. Even though the density of the foam at the pressing surface may be less or greater than the density at the center of the foam, the density of the foam at the pressing surface is preferably less than the density at the center of said foam plank. Likewise, if the foam plank has two pressing surfaces, both desirably have the aforementioned density gradient.

The blank prior to contacting with a forming tool may be cut to fit into a tool, or may be cut simultaneously, such as in die cutting where the die cutting apparatus is set up such that during the cutting, the shape is simultaneously pressed into the pressing surface, in other words, the foam is compressed into the desired shape. Lastly, the final shape may be cut from the pressed part, for example, the foam blank may be roll pressed to form the shape into the pressing surface and subsequently cut. When cutting the foam, any suitable method may be used, such as those known in the art and those described previously for cutting the foam to form a shaped foam article and/or the pressing surfaces. In addition, methods that involve heat may also be used to cut the foam since the pressed shape has already been formed in the pressing surface.

In one embodiment of the present invention, the foam plank, foam blank, foam core, or shaped foam article may be perforated. The foam plank, foam blank, foam core, or shaped foam article may have a plurality of perforations. Perforation is defined herein to mean one or more hole which passes partially into and/or entirely through the foam. Perforation may occur at any time, in other words, it may be done to the foam plank and/or foam blank prior to shaping, to the shaped foam article, or a combination of the two. The perforations may extend partially into, but not through one or both sides of the foam plank, foam blank, foam core, or shaped foam article. Alternatively, the perforations may extend through the foam plank, foam blank, foam core, or shaped foam article, for instance, for a shaped foam article made from a foam plank, the perforations may extend through the depth of the foam plank such that there is an opening through the foam from the upper surface to the lower surface. The foam may be perforated by any acceptable means. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

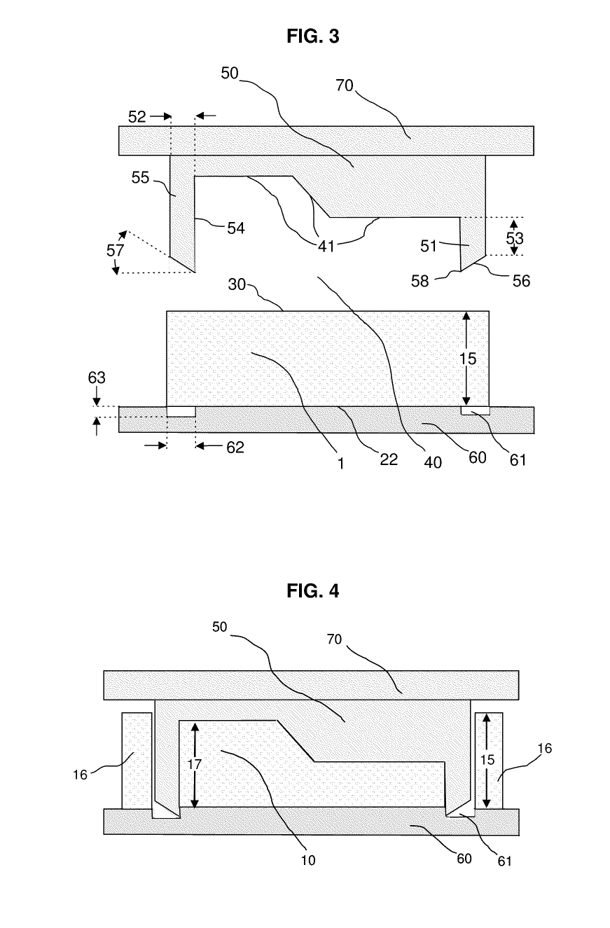

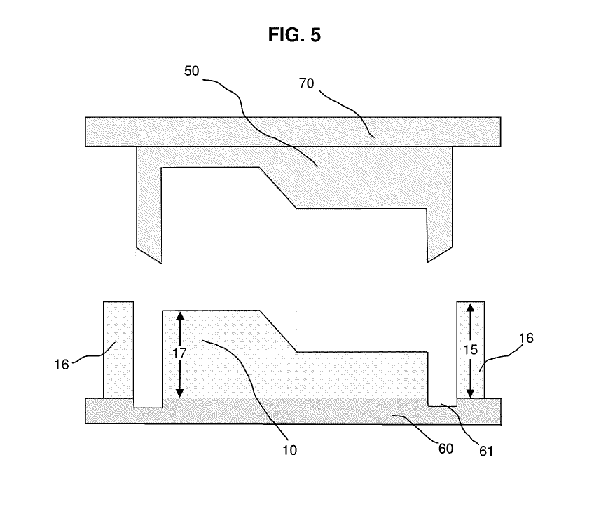

The pressing surface(s) of the blank is contacted with a forming tool such as a die face (FIG. 3 to FIG. 5). Herein die face means any tool having an impressed shape that when pressed into the foam plank will cause the foam to take the shape of the die face. That is, the material making up the die face is such that it does not deform when pressed against the foam plank, but the foam plank deforms to form and retain the desired shape of the die face.

Typically when pressing, at least a portion of the foam is pressed such that the foam is compressed to a thickness of 95 percent or less of the to be pressed foam thickness (original foam blank thickness) as shown in FIG. 1, which for some foams corresponds to just exceeding the yield stress of the foam. Likewise, when pressing the part, the maximum deformation of the foam (elastically deforming the foam) is typically no more than about 20 percent of the original thickness of the foam ready to be pressed.

The forming tool such as a die face, because a shape is most often desired, typically has contours that create an impression (step change) in height 32 of at least a millimeter in the shaped foam article 10 having thickness 17 as shown in FIG. 1. The height/depth 32 of an impression may be measured using any suitable technique such as contact measurement techniques (e.g., coordinate measuring machines, dial gauges, contour templates) and non-contact techniques such as optical methods including laser methods. The height of the step change 32 may be greater than 1 millimeter such as 1.5, 2, 2.5, 3, 3.5, 4, 5, 6, 7, 8, 9 and 10 millimeters to a height that is to a point where there are no more foam cells to collapse such that pressing further starts to elastically deform the plastic (polymer) of the foam.

The step change, surprisingly, may be formed where the foam undergoes shear. For example, the foam may have a shear angle 33 of about 45° to about 90° from the press surface 30 of the shaped foam article 10 in a step change 32. It is understood that the shear angle may not be linear, but may have some curvature, with the angle in these cases being an average over the curvature. The angle surprisingly may be greater than 60°, 75° or even by 90° while still maintaining an excellent finish and appearance.

In another aspect of the invention, a thermoplastic foam having a higher concentration of open cells at a surface of the foam than the concentration of open cells within the foam is contacted and pressed to form the shape. In this aspect of the invention the foam may be any thermoplastic foam such as the extruded styrenic polymer foam described above. It may also be any other styrenic polymeric foam such as those known in the art including, for example, where the blowing agent is added to polymer beads, typically under pressure, as described by U.S. Pat. No. 4,485,193.

With respect to this open cell gradient, the gradient is as described above for the density gradient where the concentration of open cells if determined microscopically and is the number of open cells per total cells at the surface.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing, machining, cutting, etc.) or may be induced chemically, for example, by use of suitable surfactants to burst closed cells at the surface.

The foam surface with the higher concentration of open cells is contacted with a die face and pressed as described above. In a preferred embodiment for such foams, the die faces are heated, but the foam is not (ambient 15-30° C.) and the foam is pressed. Surprisingly, the heated die faces being heated results in superior surface contour and appearance, whereas when doing the same with a foam without such open cells at the surface, the appearance of the foam is degraded.

A preferred embodiment of the present invention is a method to prepare a shaped foam composite article comprising a foam core and one or more skin comprising the steps of (A) preparing a foam core by the steps comprising (i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4 and (ii) forming a foam blank from the foam plank by preparing one or more pressing surface, (B) applying one or more skin onto one or more surface of the foam core, and providing shape to the foam core, wherein the skin(s) conform to the shape of the foam core providing a shaped foam composite article.

The order of the steps of (B) applying the skin(s) and (C) shaping the foam (and skin(s)) is not critical. In other words, the foam core may be first shaped from a foam blank into a shaped foam article and then one or more skin applied to it to form a shaped foam composite article. Alternatively, one or more skin may be applied to a foam blank to form a foam composite and then the foam composite shaped to provide a shaped foam composite article. For example, a vinyl covered foam knee bolster for an automotive application may be made by first shaping a foam knee bolster then applying a vinyl skin or, alternatively, applying vinyl to a non-shaped foam core then shaping the vinyl/foam composite into a vinyl covered foam knee bolster. The order of applying skin(s) and shaping is dictated by the application (e.g., the shaped foam composite article), the materials from which it is constructed, and the processes used to make it.

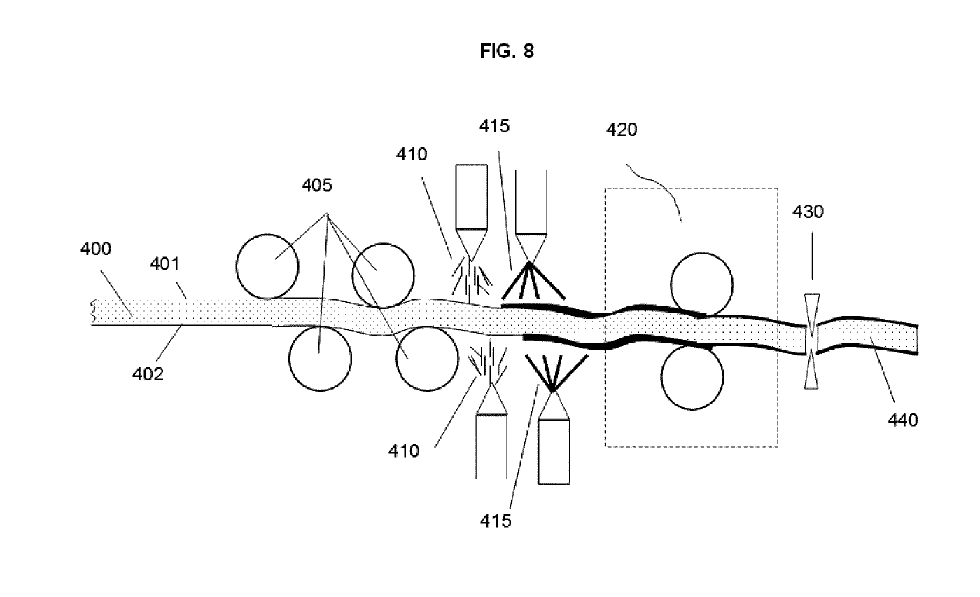

Shape may be imparted into the foam core comprising a skin, referred to as foam composite, or the foam blank prior to the application of a skin to form a shaped foam article by a continuous and/or non-continuous process. An example of a continuous process, a roll provides the shape to the foam composite/shaped foam article (FIG. 8 to FIG. 10). The roll face comprises the forming cavity (shape). Herein roll face means any roll having a defined shape that when pressed into the foam plank will cause the foam to take the shape of the roll face. That is, the material making up the roll face is such that it does not deform when pressed against the foam plank, but the foam plank deforms to form and retain the desired shape of the roll face.

Typically when pressing, at least a portion of the foam is pressed such that the foam is compressed to a thickness of 95 percent or less of the to-be-pressed foam thickness (i.e., the original foam blank thickness), which for some foams corresponds to just exceeding the yield stress of the foam. Likewise, when pressing the part, the maximum deformation of the foam (elastically deforming the foam) is typically no more than about 20 percent of the original thickness of the foam ready to be pressed.

The forming roll face, because a shape is most often desired, typically has contours that create an impression (step change) in height 32 of at least a millimeter in the shaped foam article 10 having thickness 17 as shown in FIG. 1.

In one embodiment, the process of the present invention comprises the steps of (A) shaping the foam blank with a shaping roll comprising the steps of (i) extruding a thermoplastic polymer with a blowing agent to form a foam polymer plank, the plank having a top and a bottom surface in which said surfaces lie in the plane defined by the direction of extrusion and the width of the plank, wherein the foam plank has a vertical compressive balance equal to or greater than 0.4, (ii) forming a foam blank by preparing one or pressing surface, and (iii) shaping the one or more pressing surface of the foam blank by a continuous process through one or more sets of rolls wherein one or more roll has a roll face having a defined shape which when pressed into the foam blank provides a shaped foam article with the shape of the roll face, and (B) applying one or more skin to one or more surface of the shaped foam article FIG. 8.

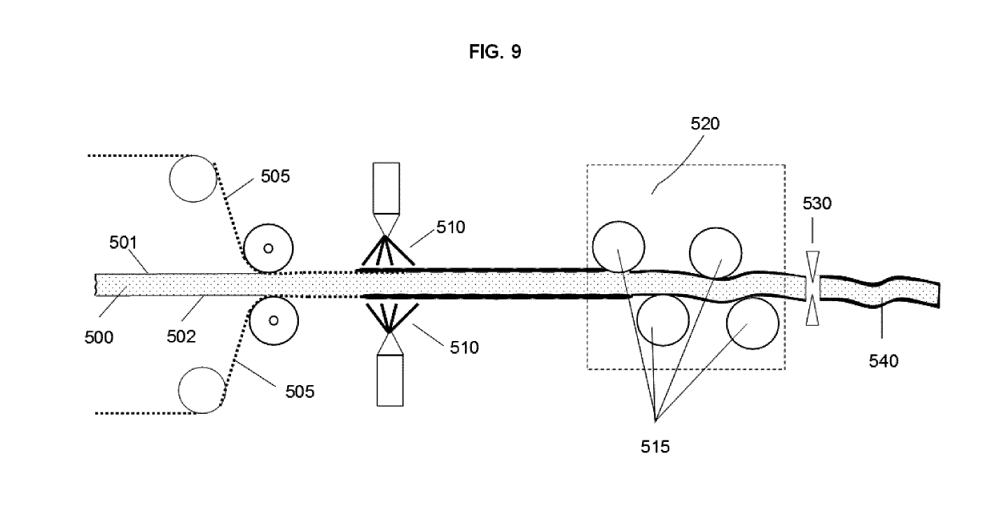

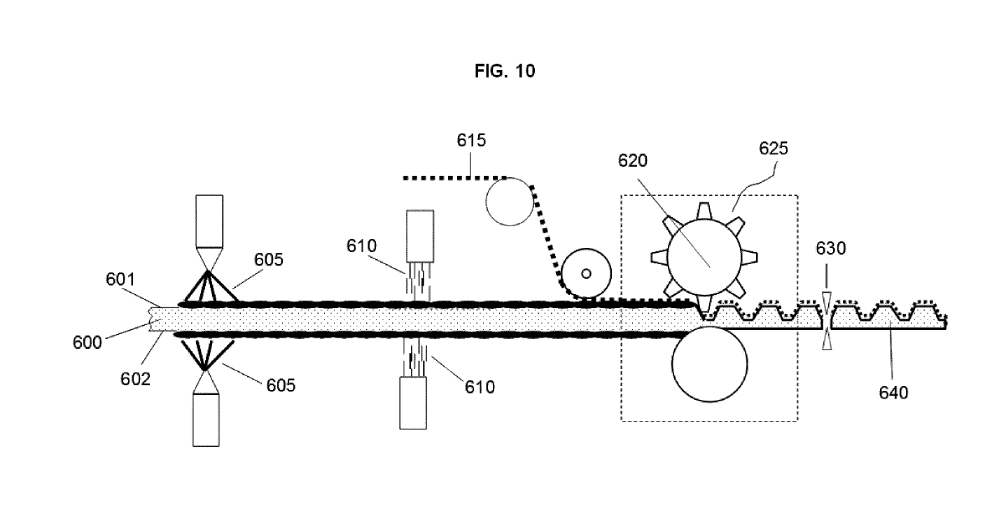

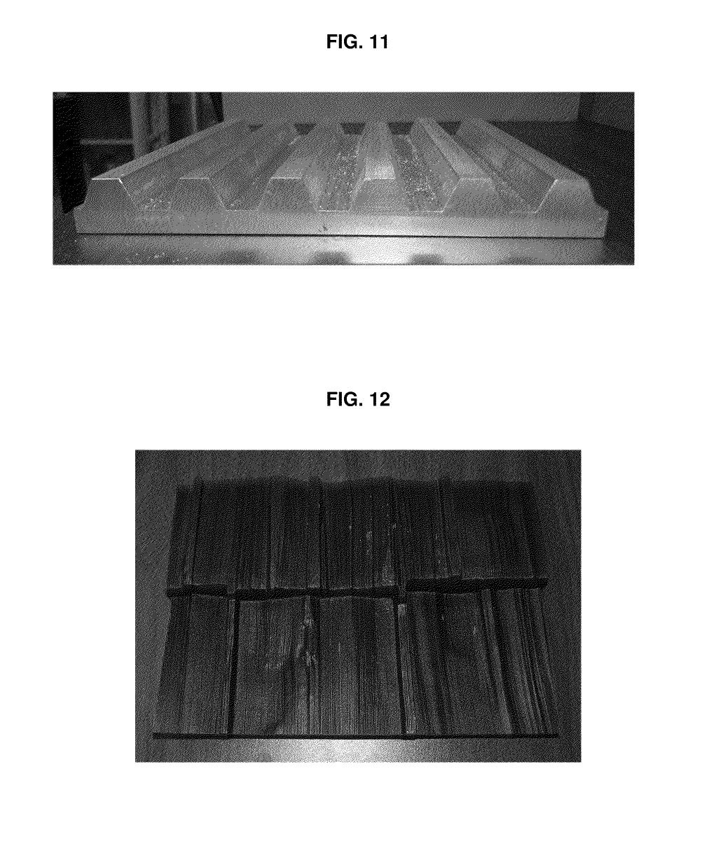

In another embodiment, the process of the present invention comprises shaping a foam composite with a shaping roll comprising the steps of (A)(i) extruding a thermoplastic polymer with a blowing agent to form a foam polymer plank, the plank having a top and a bottom surface in which said surfaces lie in the plane defined by the direction of extrusion and the width of the plank, wherein the foam plank has a vertical compressive balance equal to or greater than 0.4 and (ii) forming a foam blank by preparing one or pressing surface, (B) applying one or more skin to one or more surface of the foam blank, and (C) shaping the one or more pressing surface of the foam composite by a continuous process through one or more sets of rolls wherein one or more roll has a roll face having a defined shape which when pressed into the foam composite provides a shaped foam composite article with the shape of the roll face FIG. 9 and FIG. 10.

Either one or both of the rolls may be coated, for example with chrome, polytetrafluoroethane (PTFE, e.g., TEFLON™), a silicone compound (coating or spray applied), or the like.

In the method of the present invention the foam composite and/or foam blank may be heated prior to shaping through one or more sets of rolls. Suitable temperatures will depend on the composition of the foam and/or skin(s) as well as its thickness. Preferably, the foam composite and/or foam blank in the present method is shaped at ambient temperature.

Alternatively, the method of the present invention may use a molding machine, sometimes referred to as a press, to shape the foam composite and/or foam blank into a shaped foam article for the present invention. This process is often referred to as discontinuous as it consists of a cycle where a foam composite and/or a foam blank is placed in an open mold, the mold closes to form a shaped foam composite article or a shaped foam article, then after the shaped article is formed the mold opens. The shaped foam article is removed from the mold, a new foam composite and/or foam blank is inserted into the mold and the process repeated. This process is demonstrated for a foam blank in FIG. 3 to FIG. 7.

When using a press with a forming tool, such as a mold, the mold commonly comprises two halves. As shown in FIG. 3 to FIG. 5, one mold half (not shown in the accompanying drawings) may be affixed or mounted to the stationary platen 60 (sometimes referred to as the core side or stationary forming surface) and the other mold half 50 is affixed to the moveable platen 70 (sometimes referred to as the cavity side or movable forming surface) and moving with it. The shape of the article will dictate the design and complexity of the forming tool. In one embodiment of the present invention, the mold half with the cavity is affixed to the movable platen and the stationary forming surface is the stationary platen itself 60. In this embodiment, the stationary forming surface is flat and imparts no shape to the foam blank while the movable forming surface, or cavity, has a defined shape which is imparted into the foam blank pressing surface 30 when impressed upon the foam blank FIG. 3 to FIG. 5. In another embodiment of the present invention (not illustrated in the accompanying drawings), both the stationary and movable forming surfaces of the forming tool impart shape to the foam blank, the shape imparted to each side may be the same or different.

In one embodiment of the present invention the shaping/trimming step of the present invention, the surface of the foam blank 22 opposite the pressing surface(s) 30 of the foam blank is placed on a stationary forming surface, such as a stationary platen 60. A movable platen 70 which can move toward or away from the stationary platen on which the plank is placed comprises a movable forming surface of the forming tool 50 for example, a single cavity mold or optionally a multiple cavity mold. To shape the foam, the movable platen moves towards the stationary platen such that the pressing surface(s) of the plank 30 is contacted and pressed with the movable forming surface of the forming tool 50. For a multi-cavity mold, each cavity may be identical in shape or there may be as many different shapes as cavities or there may be a combination of multiple cavities with the same first shape in combination with multiple cavities with one or more shapes different than the first shape. The layout of cavities in a multi-cavity mold may be side by side, in tandem, or any other desirable configuration. A multi-cavity mold produces more than one shaped article in a plank per molding cycle.

When pressing with a heated forming tool such as a die face, the contact time with the foam is typically from about 0.1 second to about 60 seconds. Preferably, the dwell time is at least about 1 second to at most about 45 seconds.

When pressing with a heated forming tool such as a die face, the temperature of the die face is not so hot or held for too long a time such that the foam is degraded. Depending on the thermoplastic employed, the temperature of the die face is about 50° C. to about 200° C. Preferably, the temperature is at least about 60°, more preferably at least about 70° C., even more preferably at least about 80° C. and most preferably at least about 90° C. to preferably at most about 190°, more preferably at most about 180°, even more preferably at most about 170° C. and most preferably at most about 160° C.

The shape of the foam article is only limited by the ability to shape foam, a foam article, specifically a shaped foam article may have one or more surfaces, for example if the shaped foam article is a sphere it would have a single surface. More complex shaped foam articles will have more than one surface, for example if the shaped foam article is a bowling ball pin would have two surfaces, the continuous surface and the bottom of the pin. A rod would have three surfaces, a three sided pyramid or an extruded plank, four surfaces, a four sided pyramid, five surface, etc. Depending on the shape of the shaped foam article, it may have 1, 2, 3, 4, 5, 6, 7, 8, 9, 10 or more surfaces.

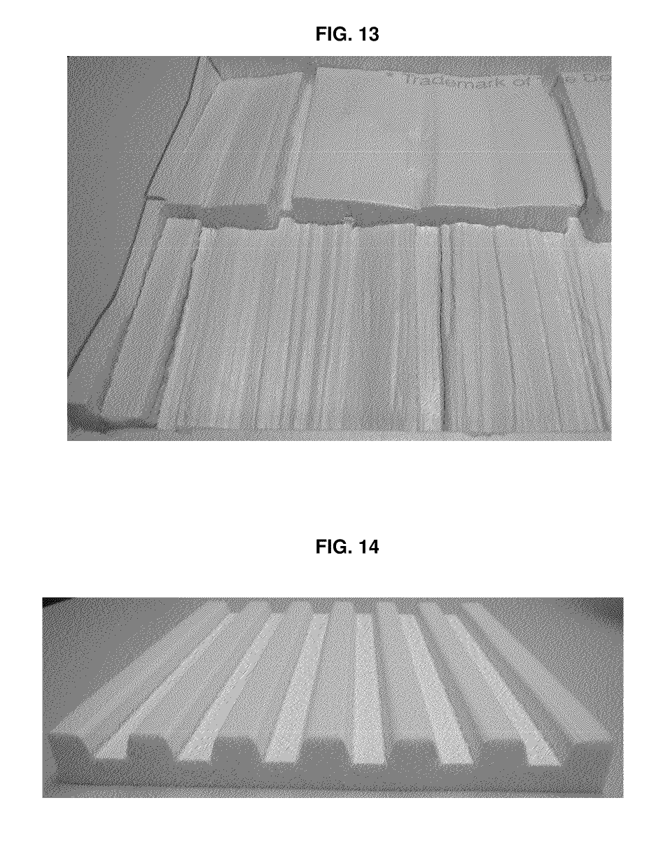

Transitions from one surface to another may be well defined, such as the six surfaces of a cube, or they may not be well defined, such as the surfaces of a complex shape such as the foam article shaped in the form of roofing shake shingles as shown in FIG. 13. A preferred shaped foam article is one in which the surface that the skin is vacuum formed onto is shaped and the opposite surface is flat, for example, if one surface (e.g., the plank's top surface) of a foam plank is shaped the opposing surface (e.g., the plank's bottom surface) is not, see FIG. 13.

When pressing a foam composite, depending on the composition of the skin(s), the die faces may or may not need to be heated. If the die faces are heated, one skilled in the art can with little experimentation determine an adequate temperature based on the composition of the skin(s).

Skins or individual layers of a skin may be applied by any suitable method. The method of forming the skin and/or the shape of the skin and the application of the skin to the foam will depend largely upon the type of material comprising the skin(s). For example, a skin or layer of a multi-layer skin may be sprayed on. Alternatively, a skin or layer may be pre-shaped (e.g., in the case of a thermoplastic polymer sheet or film or a thin metal skin) and bonded to another pre-shaped layer or the pre-shaped foam article. Any suitable method to pre-shape a skin is acceptable, for example, compression molding, thermoforming, vacuum forming, resin transfer molding, RIM, long fiber molding (LFM), infusion, roll forming, embossing, pultrusion, cam activated compression, stamping, and the like. Conversely, if the skin is applied to the foam blank prior to shaping, any suitable method described herein above may be used to shape the skin/foam composite.

Suitable materials for use as skins or layers in the skins are any material that can be applied to a foam core to provide a shaped foam composite article of the present invention. For example, skins/layers may comprise one or more of a thermoset polymer; a thermoplastic polymer; mortar; concrete; a reinforcing material such as glass or glass/polypropylene mesh; wood such as laminates, veneers, plywood, engineered lumber, particle board, and the like; metal such as aluminum, stainless steel, carbon steel, copper, brass, magnesium, galvanized metals, and the like; ceramic; leather; foam different from the foam core; Formica; cloth; fabric; stone; paint; paper; paperboard; or a combinations thereof. A skin with multiple layers may comprise several different kinds of materials, for instance a five-layer skin may comprise five materials such as a thermoplastic polymer, a thermoset polymer, a metal, cloth, and leather.

A preferred material for use as a layer in a skin or skin itself is a thermoset polymer. Any thermoset polymer is suitable for use as skins in the present invention. Preferably the skin of the present invention comprises a polyurethane (PU), an epoxy, a polyester (PES), a vinyl ester, polyimide, phenolic resins, diallyl phthalate, melamine, bulk molding compound (BMC), sheet molding compound (SMC), and the like. The thermoset may be applied in the cured form, for example as a preformed sheet or film. Alternatively, the thermoset may be applied in the uncured form. If applied in an uncured form, the thermoset may cure as it is applied or in a separate curing step after application. In one embodiment, the uncured thermoset is applied to an unshaped foam blank forming a foam composite. The thermoset is then cured during the step of shaping the foam composite into a shaped foam composite article. The cure may be done through heat, chemical reaction or irradiation such as electron beam, ultraviolet, X-ray or microwave processing

Curing time and temperature will vary according to the composition of the foam and/or the thermoset used. Care must be taken not to select a thermoset that requires a curing temperature and/or time that would negatively affect the integrity of the foam. Typically, the curing temperature for the thermoset polymer is less than 140° C., more preferably less than 120° C., more preferably less than 100° C., more preferably less than 80° C., more preferably less than 60° C., and more preferably less then 40° C. Preferably the curing temperature is equal to or greater than 23° C. Preferably the curing temperature is between 23° C. to 100° C. and more preferably it is between 23° C. and 40° C.

Any suitable process to apply the thermoset as a skin and/or layer in a skin can be employed, for example open mold processes such as hand or spray-layup, compression molding and closed mold processes such as long fiber injection (LFI), resin transfer molding (RTM), reaction injection molding (RIM), vacuum infusion, Resin film infusion, pultrusion, filament winding, tube rolling, pre-pregging and pre-forming and combinations thereof.

In another embodiment of the present invention a skin or a layer in a skin may comprise a reinforcing material. Examples of reinforcing material are fibers such as natural such as hemp, jute, wheat, flax, kenas, coconut, cotton, and the like; ceramic, glass; carbon; aramid and metal fibers; metal coated fibers; thermoset fibers; graphite; glass and other microspheres; mineral macro and nano fillers such as calcium carbonate; calcium sulfate; wollastonite; talc; mica; feldspar; kaolin; alumina; aluminum trihydrate and the like. Reinforcements can also be in the form of rovings; mats; woven; stitched or braided fabrics, prepregs, and the like. In another embodiment of the present invention a skin or a layer in a skin may comprise a reinforcing material.

In one embodiment, the foam core or shaped foam article is perforated prior to application of the thermoset polymer. When the thermoset polymer is applied some may flow into the perforations. The intrusion of the thermoset into the perforations when cured preferably results in enhanced bonding to the foam through either mechanical and/or chemical bonds.

If necessary, after application, the thermoset polymer is allowed to cure. The curing step may be a stand alone step or may occur concurrently with another step(s). There is no particular limitation as to when the curing step must occur other than what is practical as far as the overall process to manufacture a specific shaped foam composite article. In other words, when the skin comprises a thermoset polymer and optionally a reinforcing material curing of the thermoset polymer may occur prior to the shaping step, concurrently with the shaping step, or after the shaping step.

A preferred material for use as a layer in a skin or skin itself is a thermoplastic polymer. Any thermoplastic polymer is suitable for use as skins in the present invention. Preferably the skin of the present invention comprises polystyrene (PS); high impact polystyrene (HIPS); styrene and acrylonitrile copolymer (SAN); acrylonitrile, butadiene, and styrene terpolymer (ABS); polyphenyleneoxide sometimes referred to as polyphenylenether (PPO or PPE); polycarbonate (PC); polyester (PES) such as polyethylene terephthalate (PET) or polybutylene terephthalate (PBT); polyethylene (PE) including homopolymers of PE or copolymers of PE with a C₃ to C₂₀ alpha-olefin, high density polyethylene (HDPE), low density polyethylene (LDPE), linear low density polyethylene (LLDPE), substantially linear ethylene polymer (SLEP), linear ethylene polymer (LPE); polypropylene (PP) such as a homopolymer of PP or a copolymer, for example, a random or block copolymer, of PP and an alpha-olefin, preferably a C₂ or C₄ to C₂₀ alpha-olefin; thermoplastic polyolefin (TPO); olefinic thermoplastic elastomer (TPE); chlorinated polyethylene (CPE); polyvinyl chloride (PVC); polytetrafluoroethane (PTFE); polyurethane (PU); thermoplastic polyurethane (TPU); polyacrylate such polyacrylic acid (PAA), polybutyl acrylate (PBA), polymethacrylate (PMA), polymethyl methacrylate (PMMA) polyamide (PA); and blends thereof, for example PC/ABS.

The form of the thermoplastic skin used in the present invention can be a film or a sheet. The film or sheet may be mono layered or coextruded having multiple layers, i.e., 2, 3, 4, 5, 6, 7, 8, 9, 10, or more layers. If a coextruded sheet is used, one or more layers may be foamed.

The thermoplastic polymer used as the skin of the present invention may contain additives, typically dispersed within thermoplastic polymers. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

Preferably the layers of the skin are bonded directly to each other and/or the skin is bonded directly to the shaped foam article, in other words with no intervening layer of material. Adhesion between the layers of the skin and/or the skin to the foam blank and/or shaped foam article may result from one or a combination of more than one of the following means: thermal, mechanical, physical, chemical, or combinations thereof. For example, adequate adhesion between the layers of the skin and/or the skin and the foam blank and/or shaped foam article may result from thermal compatibility (i.e., heated polymer strands between the layers and/or of the skin intermingle with heated polymer strands of the shaped foam article forming a melt bond), physical compatibility (i.e., heated polymer strands of the skin are drawn into the cellular structure of the shaped foam article forming mechanical bonds), pressured engagement, fusion bonding, combinations thereof, and the like. The skin can also be conformed to the surface of the foam blank and/or the shaped foam and then adhered with mechanical means such as clips, fasteners and the like.

An adhesive may be used to bond layers of skins together and/or skins to foam blanks and/or shaped foam articles. For instance, in the case of non-thermoplastic layers and/or skins (e.g., thermoset sheet, a metal film, wood venire, cloth, fiber mat, leather, and the like) and/or non-thermoplastic foams (i.e., thermoset), and/or when the layer(s) and/or skin is a thermoplastic sheet but where thermal and mechanical bonds are inefficient to provide adequate bonding between it and another layer and/or the shaped foam article an adhesive may be employed between the layers and or the skin and the foam core, i.e., the foam blank or shaped foam article. Any adhesive capable of bonding a specific layer to another layer and/or a specific shaped foam article/skin combination is within the scope of the present invention. An effective type and amount of adhesive can be determined by one of ordinary skill in the art without undue experimentation for a given layer/layer and/or skin/foam combination.

Not to be limited to the following adhesives, a suitable adhesive may be a compound (e.g. a chemical adhesive which, for example can be a one part or multiple part adhesive such as a two component polyurethane liquid adhesive), polyurethane, epoxy, a film such as double sided tape or pressure sensitive adhesive (PSA), or another layer or film comprising a material which is compatible with (i.e., bonds to) both the foam of the shaped foam article and the skin such that the film bonds the two together.

Suitable materials for use as adhesives or in adhesive layers include those adhesive materials known in the art as useful with plastic films and foams, see U.S. Pat. No. 5,695,870, which is hereby incorporated by reference. Examples include polyolefin copolymers such as ethylene/vinyl acetate, ethylene/acrylic acid, ethylene/n-butyl acrylate, ethylene/methylacrylate, ethylene ionomers, and ethylene or propylene graft anhydrides. Other useful adhesives include urethanes, copolyesters and copolyamides, styrene block copolymers such as styrene/butadiene and styrene/isoprene polymers, acrylic polymers, and the like. The adhesives may be thermoplastic or curable thermoset polymers, and can include tacky, pressure-sensitive adhesives. The adhesive or adhesive layer is preferably recyclable within the foam board manufacturing process. The adhesive material must not negatively impact the physical integrity or properties of the foam to a substantial degree.

For example, suitable adhesives are foam craft adhesives such as 3M Styrofoam Spray Adhesive, adhesives based on dispersions, e.g. ACRONAL™ Acrylate Dispersions available from BASF, one-component polyurethane adhesive such as INSTASTIK™ available from The Dow Chemical Company, hot-melt adhesives, moisture-cured adhesives such as those described in U.S. Pat. No. 7,217,459B2, which is hereby incorporated by reference, single- or preferably two-component adhesives based on polyurethane resins or on epoxy resins, see USP 20080038516A1, which is hereby incorporated by reference, and the like.

In one embodiment of the present invention, adhesion between the skin to the foam blank and/or shaped foam article may be enhanced if the bonding surface of the foam blank and/or shaped foam article is rough, for example the shaped foam article is formed in a textured tool, or the bonding surface of the foam blank and/or shaped foam article prior to adhesion may be abraded (e.g., with a rasp, file, sandpaper, or the like), scratched, sand blasted, particle blasted, or the like.

Mechanical means may be used to bond a skin to a surface of the foam. For example, fasteners, snap fits, clips, mounting points, joints, channels, Velcro, and the like may be used. These features may be molded into wither the foam or the skin or both.

One embodiment of the present invention is a shaped foamed composite article wherein a skin is vacuum formed onto a shaped foamed article. The skin of the present invention can be any material capable of being vacuum formed. Vacuum forming is well known. As the name implies, vacuum forming is the forming or shaping of a material by the application of pressure wherein the pressure is brought about by a vacuum on one side of the material. Depending on the composition of the material, typically, heat is also applied. Any material capable of being vacuum formed is suitable for the skin of the present invention. For example, the skin may comprise a thermoset sheet, a metal film, wood venire, glass, cloth, fiber mat, ceramic, leather, inflammable coatings, and the like. Preferably, the skin is a sheet comprising a thermoplastic polymer. Skin materials can be used independently or in combinations or mixtures thereof, for instance a suitable skin may be a coextruded sheet having 2 or more (3, 4, 5, 6, 7, 8, 9, 10, etc.) thermoplastic layers which may be of the same or different thermoplastic materials or the skin could be a laminate of different materials such as a fabric and leather or a metal film and a thermoplastic sheet. By convention, material equal to or greater than 1 mm thick is called sheet or sheeting and material less than 1 mm thick is called film.

The shaped foam article is perforated by any acceptable means to provide sufficient vacuum through the article to allow vacuum forming the skin onto part of one, one, or more of its surfaces. The shaped foam article has a plurality of perforations. The perforations extend through the shaped foam article, for instance for a shaped foam article made from a foam plank, through the depth of the foam plank so as to allow a vacuum to be pulled through the shaped foam article. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

In the process of the present invention a perforated shaped foam article is placed into a fixture equipped with a means to pull a vacuum, for example a vacuum inlet port. Vacuum is pulled through the perforations of the perforated shaped foam article of the invention. The fixture may be flat or contoured to match one or more surface of the shaped foam article. The surface or surface(s) of the perforated shaped foam article that fit within the fixture is/are the surface(s) which the skin is not vacuum formed onto. In other words, at least part of one surface, one surface, or more than one surface of the shaped foam composite article of the present invention is not covered by the vacuumed formed skin (this is referred to as the non-skin-bonded surface(s)). Moreover, in the process of the present invention, a part of one surface, one surface, or more than one surface of the shaped foam article is vacuum formed with a skin to produce the shaped foam composite article of the invention (this is referred to as the skin-bonded surface(s)). Preferably the vacuum pressure is at least 5 psi, more preferable at least 7 psi and most preferable 10 psi or greater. Preferably, the vacuum duration is less than 1 second and most preferably less than at least 2 seconds.

When the skin is one or more thermoplastic sheet, one or more coextruded sheet, or combinations thereof sufficient heat must be applies to soften the sheet forming a preheated sheet that may then be vacuumed formed onto the perforated shaped foam article. The temperature will vary depending on the thermoplastic employed; however a suitable temperature is preferably near, at, or above the glass transition temperature (T_{g}) for the thermoplastic sheet being vacuum formed.

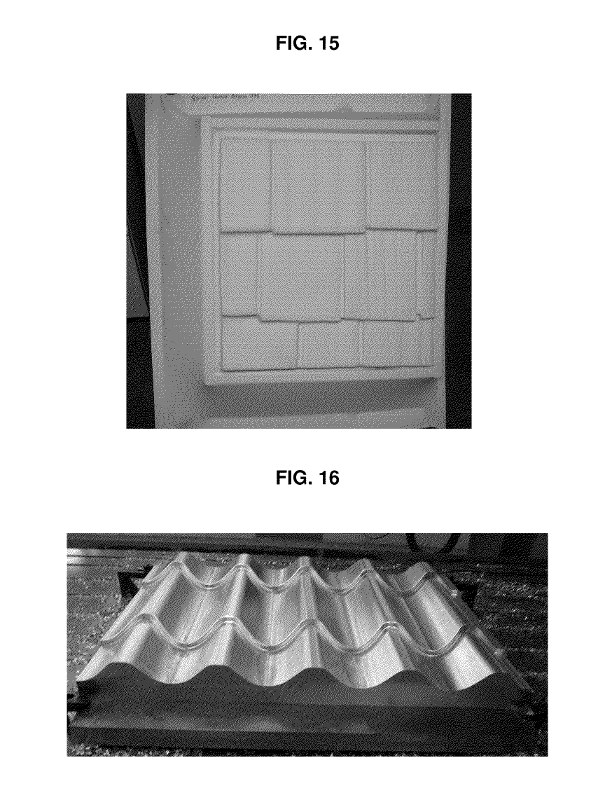

Means are well known to one of ordinary skill in the art to clamp, heat, and maneuver the softened thermoplastic sheet into the desired position relative the fixture comprising the perforated shaped foam article to allow vacuum forming the preheated sheet onto the perforated shaped foam article. The fixture comprising the perforated shaped foam article and the softened thermoplastic sheet are mated, for example by hydraulic actuation of the fixture into the preheated thermoplastic sheet, and sufficient vacuum is applied to draw the preheated thermoplastic sheet against the surface(s) of the perforated shaped foam article forming a shaped foam composite article of the present invention. The shaped foam composite article is allowed to cool and removed from the fixture, FIG. 15. If necessary, any excess skin is trimmed from the shaped foam composite article.

Prior to vacuum forming the skin to the shaped foam article, the adhesive can be applied to the skin-bonding surface of the shaped foam article, the skin-bonding surface of the skin, or both the skin-bonding surface of the shaped foam article and the skin-bonding surface of the skin. The adhesive may be automatically or manually applied by any means, such as spraying, brushing, robotically dispensing, dipping, pouring, positioning, sticking, etc.

In one embodiment, the process of the present invention comprises the steps of (i) providing a perforated shaped foam article and (ii) vacuum forming a skin onto the perforated shaped foam article to provide a shaped foam composite article. The shaped foam article may be made by (1) directly foaming a shaped foam article or by (2) shaping an article from a foam plank by any suitable method, i.e., by abrasive wire cutting, hot wire cutting, die cutting, water jet cutting, milling, match mold thermoforming, continuous role forming compression, or combinations thereof. The order of the steps regarding (a) shaping and (b) perforating the foam article is not important as long as the shaped foam article is adequately perforated prior to the vacuum forming step. For instance, a first embodiment of the method of the present invention is to form a shaped foam article then perforate it to provide a perforated shaped foam article, another embodiment of the method of the present invention is to shape a foam article from a foam plank then perforate the shaped foam article to provide a perforated shaped foam article, yet another embodiment of the method of the present invention is to perforate a foam plank and then shape the perforated foam plank to provide a perforated shaped foam article.

Vacuum forming, while a useful and often time practical method to apply the skin to the shaped foam article, is not the only method to bond a skin and foam core. In many cases vacuum forming is either impractical or impossible depending on the shape of the shaped foam article and/or the composition of the skin or other factors. In the present invention, the most preferred process of applying one or more skin onto a foam core, whether the foam core is a shaped foamed article or a foam blank, is by a means other than vacuum forming, in other words, applying one or more skin to the foam core by any means excluding vacuum forming. Other methods to produce and/or shape and/or apply skins to foam cores have been discussed herein above and include but are not limited to (this list is not inclusive): thermal means, mechanical means, physical means, chemical means, adhesive means, spraying, dipped, dispersion, tube rolling, filament winding, pre-pregging, hand lay-up, plating, metalizing, metal sputtering, shrink wrapping, injection molding, blow molding, compression molding, resin transfer molding, reaction injection molding, long fiber molding, thermoforming, infusion, vacuum infusion, roll forming, embossing, pultrusion, cam actuated compression, or combinations thereof.

Such methods may be utilized to apply a skin to the foam core prior to or after the shaping step. If the skin is applied after the foam core is shaped into a shaped foam article, the skin may be applied directly to the shaped foam article surface and conform to its shape, for example if the skin is sprayed on, dipped, shrink wrapped, etc., or the skin may be pre-shaped, for example thermoformed, compression molded, injection molded, roll formed, etc., to conform to the shaped surface of the shaped foam article then adhered. The following embodiments exemplify a few of the preferred methods, other than vacuum forming, to apply one or more skin to a foam core to provide a shaped foam composite article of the present invention. These examples are not intended limit the scope of the present invention; rather they are intended to demonstrate methods of applying one or more skin onto the shaped foamed article by means excluding vacuum forming.

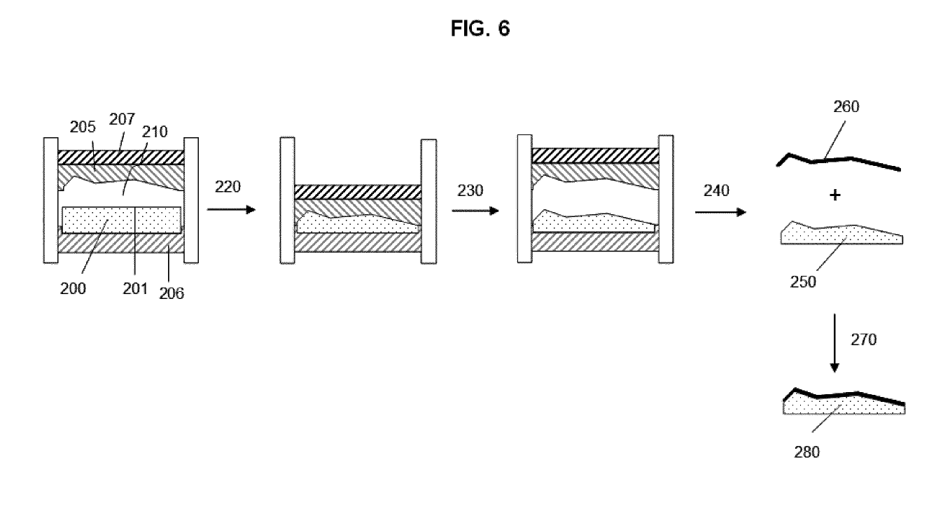

In one embodiment of the present invention a shaped foam composite of the present invention is produced by a discontinuous process FIG. 6. A foam blank 200 with its the upper surface a pressing surface 201 is inserted into an open press between the movable platen 207 and stationary platen 206. The press has a mold 205 comprising a cavity 210 having a defined shape affixed to the movable platen 207 and the foam blank rests on the stationary platen 206. The mold is closed 220 pressing the surface of the mold cavity against the pressing surface 201 of the foam blank 200 forming a shaped foam article 250. After shaping, the mold opens 230 and the shaped foam article 250 is removed 240. A skin 260 (which can be pre-formed or one that can conform to the shape of the shaped foam article) is affixed 270 to the shaped foam article 250 to form a shaped foam composite article 280.

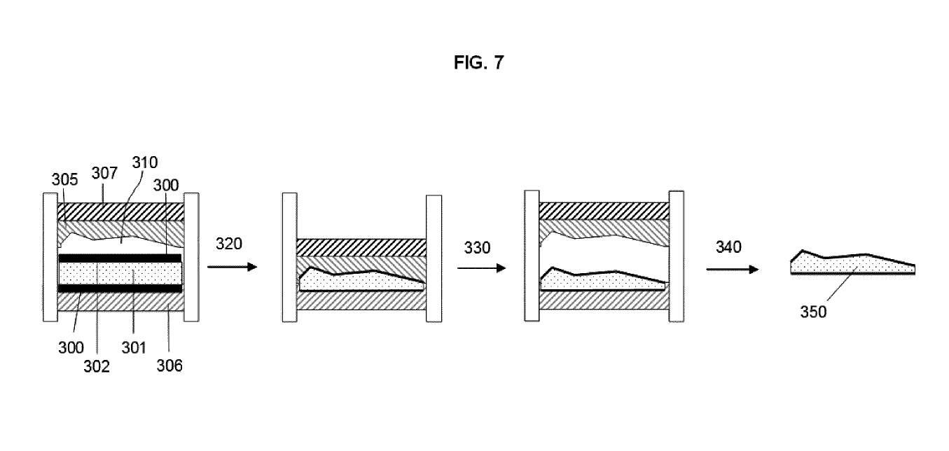

In one embodiment of the present invention a shaped foam composite of the present invention is produced by an alternative discontinuous process FIG. 7. A skin 300 comprising glass and an uncured polyurethane polymer is applied to the upper and lower surface of a foam blank 301 the upper surface of the foam blank comprises a pressing surface 302. The foam composite is inserted between the open movable 307 and stationary platens 306 of a molding press wherein the movable platen comprises a mold half 305 with a cavity 310 having a defined shape and stationary platen comprises a mold half with a cavity having a defined shape. The mold is closed 320 pressing the surfaces of the mold cavities against the glass/thermoset polyurethane foam composite shaping the foam composite and curing the polyurethane skins at the same time. After shaping, the mold opens 330 and the shaped foam composite article 350 is removed 340.

In another embodiment of the present invitation a shaped foam composite article is produced by a continuous process FIG. 8. A foam blank 400 having two pressing surfaces 401 and 402 is fed through shaping rolls 405 imparting shape to both upper and lower surfaces of the foam blank. After the blank has been shaped, a skin comprising fiber glass 410 and a thermoset polymer 415 is applied to both sides of the shaped foam blank. Subsequently, the thermoset polymer is cured 420, optionally the continuous shaped foam composite is cut 430 to provide a shaped foam composite article 440.

In yet another embodiment of the present invitation a shaped foam composite article is produced by a second continuous process FIG. 9. A glass fabric 505 is applied to both surfaces of a continuously fed foam blank 500 having two pressing surfaces 501 and 502. After the application of the glass fabric, a thermoset polymer 510 is applied to the glass fabric on both sides of the foam blank forming a foam composite; combination of the glass fabric and thermoset polymer comprise the skin. The/glass/thermoset coated foam composite is transported to and through a set of forming rolls 515 wherein shape from the forming rolls is imparted to one or both sides of the foam composite while concurrently curing 520 the thermoset polymer optionally the shaped foam composite is cut 530 to provide a shaped foam composite article 540.

In yet another embodiment of the present invitation a shaped foam composite article is produced by a third continuous process FIG. 10. A first layer of the skin comprising a thermoset polymer 605 and fiber glass 610 is applied to both surfaces of a continuously fed foam blank 600 having two pressing surfaces 601 and 602 on the upper and lower surfaces, respectively. After the application of the first skin layer (thermoset polymer and the fiber glass) a second layer comprising a thin metal foil 615 is added to the top surface of the first layer of the skin on the upper surface of the foam blank. The thermoset/fiber glass/metal foil coated foam composite is transported to and through a stamping operation 620 wherein shape is imparted to one or both sides of the foam composite while concurrently curing 625 the thermoset polymer optionally cutting 630 the thermoset/fiber glass/metal foil/foam to provide shaped foam composite article 640.

In yet another embodiment of the present invitation a shaped foam composite article is produced by the continuous process shown FIG. 10 wherein the second layer 615 making up the top skin is a thermoplastic film.

### Test Methods

The density profile through the thickness of each foam blank was tested using a QMS Density Profiler, model QDP-01X, from Quintek Measurement Systems, Inc. Knoxyille, Tenn. The High Voltage kV Control was set to 90 percent, the High Voltage Current Control was set to 23 percent and the Detector Voltage was approximately 8v. Data points were collected every 0.06 mm throughout the thickness of the foam. Approximate thickness of the foam samples in the plane of the x-ray path was 2 inches. Mass absorption coefficients were calculated for each sample individually, based on the measured linear density of the foam part being tested. The skin density, ρₛₖᵢₙ, was reported as a maximum value whereas the core density, ρ_{core}, was averaged within an approximate 5 mm range. The density gradient, in units of percentage, was then computed in accordance with the following equation:

$$Density Gradient ( percent ) = 100 \cdot \frac{( {ρ}_{core} - {ρ}_{skin} )}{{ρ}_{skin}}$$

The compressive response of each material was measured using a Materials Test System equipped with a 5.0 displacement card and a 4,000 lbf load card. Cubical samples measuring the approximate thickness of each plank were compressed at a compressive strain rate of 0.065 s⁻¹. Thus, the crosshead velocity of the MTS, in units of inches per minute, was programmed in accordance with the following equation:

Crosshead Velocity=Strain Rate*Thickness*60

where the thickness of the foam specimen is measured in units of inches. The compressive strength of each foam specimen is calculated in accordance with ASTM D1621 while the total compressive strength, C_{ST}, is computed as follows:

C_{ST}=C_{SV}+C_{SE}+C_{SH}

where C_{SV}, C_{SE} and C_{SH} correspond to the compressive strength in the vertical, extrusion and horizontal direction respectively. Thus, the compressive balance, R, in each direction can be computed as shown below:

R_{V}=C_{SV}/C_{ST}

R_{E}=C_{SE}/C_{ST}

R_{H}=C_{SH}/C_{ST}

Open cell content was measured by using an Archimedes method on 25 mm×25 mm×50 mm samples.

While certain embodiments of the present invention are described in the following example, it will be apparent that considerable variations and modifications of these specific embodiments can be made without departing from the scope of the present invention as defined by a proper interpretation of the following claims.

Percent crack reduction Cᵣ can be determined from the ratio of the rough crack value R_{cv} to the smooth crack value S_{cv} by the following formula:

Cᵣ=(1−R_{cv}/S_{cv})*100

Wherein crack values are manually calculated for a shaped foam article pressed by a mold with a smooth cavity surface S_{cv} by first measuring the length of each crack in the shaped foam article (or a specified portion thereof) made from a mold with a smooth cavity surface and then adding each of the individual crack lengths together to get an overall smooth crack value S_{cv} in units of length. Crack values are manually calculated for a shaped foam article pressed by a mold with a reduced-slip cavity surface R_{cv} by first measuring the length of each crack, if any, in the shaped foam article (or the same specified portion as used in the shaped foam article pressed from the mold with a smooth cavity surface) made from a mold with a reduced-slip cavity surface and then adding each of the individual crack lengths together to get an overall reduced-slip crack value R_{cv} in units of length.

### Example 1

About 5 millimeters (mm) layer is removed by planing from the top and the bottom of an IMPAXX™ 300 Foam Plank, available from The Dow Chemical Co., Midland, Mich. This foam plank is an extruded polystyrene foam with dimensions measuring 110 mm by 600 mm by 2,200 mm in the thickness, width and length directions respectively. The IMPAXX 300 Foam Plank has a Rv of about 0.59, a density gradient of about 18.6 percent, an open cell content of about 4.9 percent, and a cell gas pressure of about 0.6 atmosphere (atm). The planed plank is perforated using an offline perforator equipped with a series of 2.0 mm diameter needles approximately 8.5 inches (in.) in length. The needles are spaced approximately 0.5 in. apart and the frequency of the perforation machine was set at approximately 20 Hertz (Hz), resulting in a rectangular perforation pattern of 0.5 in. by 0.75 in. to the foam plank. The plank is fed lengthwise through the perforator, thus, the 0.5 in. spacing is imposed to the width direction of the plank whereas the 0.75 in. spacing is imposed to the length direction of the plank, respectively.

Next, the perforated IMPAXX 300 Foam Plank is cut to render a foam blank measuring approximately 20 in. by 20 in. by 2 in., in the length, width and thickness directions respectively. The cut, or core, surface of the foam blank is then compressed against the surface of a prototype cast tool in the shape of shake shingles at ambient temperature until the upper platen contacted a series of 0.75 in. stop blocks. Once the stop blocks are contacted, the platens are opened and the perforated shaped foam article is removed from the surface of the casting tool. During the pressing, the foam is subjected to an applied strain of about 60 to about 65 percent.

The formed perforated shaped foam article is placed in a wooden fixture equipped with a vacuum inlet port on the base of the fixture. The skin comprises a 24 in. by 24 in. by 0.080 in. thick coextruded STYRON™ 1170 High Impact Polystyrene (HIPS) Resin. The coextruded sheet is a three layer structure (i.e., ABA) with solid skins (i.e., A layers) and the material in the center (i.e. B layer) foamed with a chemical blowing agent. The coextruded sheet is edge clamped and pre-heated to approximately 400° F. using an AVTshuttle thermoformer. Upon reaching the desired surface temperature, the sheet is shuttled over the perforated shaped foam article which is plunged vertically into the pre-heated sheet through the use of hydraulic actuation. Vacuum is applied and the pre-heated sheet is drawn against the formed part surface and allowed to cool with the use of multiple fans. Vacuum was applied at approximately 0.5 atmospheres (i.e. 7.3 psi) for 12 seconds. Chemical compatibility between the perforated shaped foam article and the thermoplastic skin results in exceptional adhesion at the foam-sheet interface. A photograph of the composite foam panel is shown in FIG. 15.

While certain embodiments of the present invention have been described in the preceding example, it will be apparent that considerable variations and modifications of these specific embodiments can be made without departing from the scope of the present invention as defined by a proper interpretation of the following claims.

The cut, or core, surface of the foam blank is then compressed against the surface of a prototype cast tool in the shape of shake shingles at ambient temperature until the upper platen contacted a series of 0.75 in. stop blocks. Once the stop blocks are contacted, the platens are opened and the perforated shaped foam article is removed from the surface of the casting tool. During the pressing, the foam is subjected to an applied strain of about 60 to about 65 percent.

Vacuum is applied and the pre-heated sheet is drawn against the formed part surface and allowed to cool with the use of multiple fans. Vacuum was applied at approximately 0.5 atmospheres (i.e. 7.3 psi) for 12 seconds. Chemical compatibility between the perforated shaped foam article and the thermoplastic skin results in exceptional adhesion at the foam-sheet interface. A photograph of the composite foam panel is shown in FIG. 15.

### Examples 2 to 3

For Examples 2 to 3 a shaped foam article resembling Spanish roofing tiles is first produced and then a mono-layer skin is attached to the shaped surface of the shaped foam article to provide a shaped foam composite article. The process of Examples 2 and 3 is exemplified in FIG. 6. Example 2 is a copper skin and Example 3 is a concrete skin.

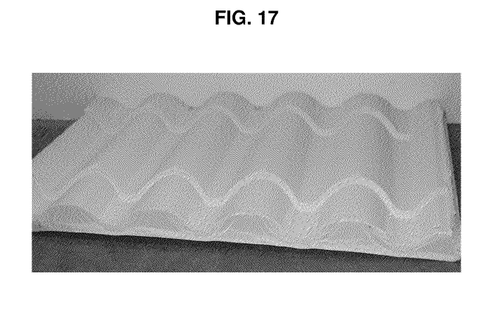

In both Examples the shaped foam article is manufactured by the following method: An IMPAXX 300 Foam Plank, available from The Dow Chemical Co., Midland, Mich. is used. The IMPAXX 300 Foam Plank is an extruded polystyrene foam with dimensions measuring 2,200 mm by 600 mm by 110 mm in the length, width and thickness directions respectively. The IMPAXX 300 Foam Plank has a Rv of about 0.59, a density gradient of about −18.6 percent, an open cell content of about 4.9, and a cell gas pressure of about 0.6 atm. About 7 millimeters (mm) layer is removed by planing from the top and the bottom of an IMPAXX 300 Foam Plank. The planed IMPAXX 300 Foam Plank is then cut to render a foam blank having a planed surface (top or bottom) opposite a cut surface (core) measuring approximately 355 mm by 241 mm by 50 mm, in the length, width and thickness directions respectively. The cut, or core, surface of the foam blank is then compressed against the movable forming surface comprising a mold cavity in the shape of Spanish roofing tiles FIG. 16 at ambient temperature until the movable upper platen contacts a series of 19 mm stop blocks. Once the stop blocks are contacted, the platens are opened and the shaped foam article resembling a panel of Spanish roofing tiles FIG. 17 is removed from the surface of the casting tool with no dwell or residence time in the mold. During the pressing, the foam is subjected to a maximum applied compressive strain of about 60 to about 65 percent.

The foam blank is pressed by an aluminum compression fixture (mold) with a pressing surface milled in the shape of Spanish roofing tiles. The resulting shaped foam article is a panel with the appearance of Spanish roofing tiles measuring 997 mm×600 mm×78 mm. The periphery of the mold cavity/panel is defined by a trimming rib measuring about 0.38 inch (in.) wide and about 1,125 in. long. The fixture is mounted to the movable platen of a MTS Millutensil Spotting Press. The Millutensil is programmed for a crosshead velocity of 12 inch per minute (in./min) and the foam sample is compressed 2.25 in. (i.e., the movable platen is 0.75 in. from the stationary platen). The pressing surface of the mold cavity is textured with a media blasted with a Wheelabrator 48 inch Spin Blast media blaster loaded with SN-460 Steel Nugget media. The tool was processed within the Wheelabrator for a couple of minutes to sufficiently texture the surface.

### Example 2

A 0.020 inch thick aluminum facer with the same shape of Spanish roof tile shape of the above described shaped foam article is formed via traditional sheet metal forming to match the outer surface of the shaped foam article.

The shaped foam article and copper facer are mated together using Mor-Ad 652 available from Rohm and Haas one part urethane adhesive by applying 12 grams of the adhesive per square foot is spread on the outer surface of the foam part and lightly misting with 2 grams per square foot of water. The metal facer is mated with the corresponding foam surface. It is then placed in the press to apply 14 PSI of pressure for one hour. The pressure is released and the final shaped foam composite article is removed from the press.

### Example 3

A 0.25 inch thick concrete facer with the same shape of Spanish roof tile shape of the above described shaped foam article is precast to match the outer surface of the shaped foam article.

The shaped foam article and concrete facer are mated together using Mor-Ad 652 one part urethane adhesive by applying 12 grams of the adhesive per square foot is spread on the outer surface of the foam part and lightly misting with 2 grams per square foot of water. The concrete facer is mated with the corresponding foam surface. It is then placed in the press to apply 14 PSI of pressure for one hour. The pressure is released and the final shaped foam composite article is removed from the press.

### Examples 4 to 5

For Examples 4 and 5 a 400 ton Kraus Maffei press is used having a mold measuring 1200 mm by 1200 mm with an adjustable depth of up to 400 mm. The mold cavity is attached to the movable platen. The stationary platen is used as the second forming surface. The molded foam article is a rectangular shaped and is flat on the stationary platen side and has a step change pressed into the molded side, the step change comprises a raised rectangular shape in the center of the foam measuring 280 mm by 150 mm with a height of 15 mm. The mold is heated to 75° C. The foam composite comprises a foam blank and mono-layer skins comprising a non-woven glass mat impregnated with a rigid polyurethane.

In Examples 4 and 5, the foam is an IMPAXX 300 Foam Plank, available from The Dow Chemical Co., Midland, Mich. The IMPAXX 300 Foam Plank has a Rv of about 0.59, a density gradient of about −18.6 percent, an open cell content of about 4.9, and a cell gas pressure of about 0.6 atm. This foam plank is an extruded polystyrene foam with dimensions measuring 86.5 inches by 23.5 inches by 4.3 inches thick. Pressing surfaces are prepared by removing about 5 mm by planing from the top and the bottom of the IMPAXX 300 Foam Plank. The IMPAXX 300 Foam Plank is cut to render an IMPAXX 300 Foam blank measuring approximately 20 inches by 20 inches by 2 inches, in the length, width and thickness directions respectively.

The non-woven glass mat measures 24 inches by 24 inches by 0.080 inches thick and is available as a sheet from Lowes Home Improvement store. The glass mat is impregnated with a rigid polyurethane system SPECTRIM™ MM310 polyol and PAPI™ 27 methylene diphenyl diisocyanate (MDI), both available from The Dow Chemical Company. The polyurethane coating is sprayed on the glass matt to adequately wet out the glass mat.

### Example 4

The shaped foam composite article of Example 4 is prepared by the following steps and the process is exemplified in FIG. 6:
1. The IMPAXX 300 Foam blank is placed on the stationary platen.
2. The mold is closed and 25 tons of clamp pressure applied and held for three minutes to provide a shaped foam article.
3. The mold is opened and the shaped foam article is removed.
4. Mold release is sprayed on the stationary platen and the mold surfaces.
5. Non-woven glass mat is placed on the stationary platen and impregnated with the rigid polyurethane system.
6. The shaped foam article is placed on top of the impregnated glass mat.
7. A second non-woven glass mat is placed on top of shaped foam article and the rigid polyurethane system is applied.
8. The mold is closed and the polyurethane is allowed to cure to provide a shaped foam composite article.

### Example 5

The shaped foam composite article of Example 5 is prepared by the following steps and the process is exemplified in FIG. 7:
1. Mold release is sprayed on the stationary platen and the mold surfaces.
2. A first sheet of non-woven glass mat is placed on the stationary platen.
3. The rigid polyurethane system is sprayed onto the first glass mat.
4. The IMPAXX 300 Foam blank is placed on top of this polyurethane impregnated glass mat.
5. A second sheet of non-woven glass mat is placed on top of the IMPAXX 300 Foam blank.
6. The rigid polyurethane system is sprayed onto the second glass mat.
7. The mold is closed and 25 tons of clamp pressure applied and held for three minutes during which time the urethane cures.
8. The mold is opened and the shaped foam composite article is removed.

1. A method to manufacture a shaped foam composite article comprising a foam core and one or more skin comprising the steps of:
(A) preparing a foam core by the steps comprising:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4
and
(ii) forming a foam blank from the foam plank by preparing one or more pressing surface,
(B) applying one or more skin onto one or more surface of the foam core,
and
(C) providing shape to the foam core,
wherein the skin(s) conform to the shape of the foam core providing a shaped foam composite article.

2. A method to manufacture a shaped foam composite article comprising a foam core and one or more skin comprising the steps of:
(A) preparing a foam core comprising a shaped foamed article comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4,
(ii) forming a foam blank from the foam plank by preparing one or more pressing surface,
(iii) shaping the pressing surface(s) of the foam blank to provide a shaped foam article
and
(B) applying one or more skin onto the shaped foamed article,
wherein the one or more skin may independently be a mono-layer skin, a multi-layer skin, or combinations thereof.

3. The method of claim 2 wherein step (iii) further comprises the steps:
(iii)(a) contacting each pressing surface of the foam blank with a mold, said mold comprises one or a plurality of cavities each cavity having a perimeter defining the shape of the shaped foam article and a cavity surface and
(iii)(b) pressing the foam blank with the mold at an applied strain whereby forming one or more shaped foam article and surrounding continuous unshaped foam blank.

4. A method to manufacture a shaped foam composite article comprising a foam core and one or more skin comprising the steps of:
(A) preparing a foam core comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4
and
(ii) forming a foam blank from the foam plank by preparing one or more pressing surface,
(B) applying a skin onto one or more pressing surface to provide a foam composite blank,
and
(C) shaping the foam composite blank into a shaped foam composite article,
wherein one or more skin may independently be a mono-layer skin, a multi-layer skin, or combinations thereof.

5. The methods of claims 1, 2 or 4 wherein the blowing agent is a chemical blowing agent, an inorganic gas, an organic blowing agent, or combinations thereof.

6. The methods of claims 1, 2 or 4 wherein the thermoplastic polymer is a styrene polymer, a styrene and acrylonitrile copolymer, or mixtures thereof and the blowing agent is carbon dioxide, water or a combination thereof.

7. The method of claims 1, 2 or 4 wherein one or more skin comprises one or more layer independently comprising a thermoplastic polymer, thermoset polymer, a metal, a wood veneer, cloth, fabric, paint, stone, paper, paper board, a reinforcing material, a fiber mat, leather, concrete, ceramic, or combinations thereof.

8. The method of claim 7 wherein one or more mono-layer skin and/or one or more multi-layer skin comprises a sheet or a film.

9. The method of claim 8 wherein the sheet or film comprises a thermoplastic polymer selected from polystyrene; high impact polystyrene; styrene and acrylonitrile copolymer; acrylonitrile, butadiene, and styrene terpolymer; polyphenyleneoxide; polycarbonate; polyethylene terephthalate; polybutylene terephthalate; copolymers of PE with a C₃ to C₂₀ alpha-olefin, high density polyethylene, low density polyethylene, linear low density polyethylene, substantially linear ethylene polymer, linear ethylene polymer; polypropylene homopolymer; random copolymer of polypropylene; block copolymer of polypropylene; copolymer of propylene with a C₄ to C₂₀ alpha-olefin; thermoplastic polyolefin; olefinic thermoplastic elastomer; chlorinated polyethylene; polyvinyl chloride; polytetrafluoroethane; polyurethane; thermoplastic polyurethane; polyacrylic acid; polybutyl acrylate; polymethacrylate; polymethyl methacrylate; polyamide; and blends thereof.

10. The methods of claims 1, 2 or 4 wherein one or more skin comprises one or more layer independently comprising a thermoset polymer and optionally a reinforcing material wherein curing of the thermoset polymer may occur prior to the shaping step, concurrently with the shaping step, or after the shaping step.

11. The method of claims 1, 2 or 4 wherein one or more skin is adhered to the shaped foam article by thermal means, mechanical means, physical means, chemical means, adhesive means, or combinations thereof.

12. A shaped foam composite article made by the method of claims 1, 2 or 4.
